(19) United States
(12) Patent Application Publication
(10) Pub. No.: US 2015/0111104 A1
(43) Pub. Date: Apr. 23, 2015

(54) LITHIUM-SULFUR CELL

(71) Applicant: ROBERT BOSCH GMBH, Stuttgart (DE)

(72) Inventors: Christine Engel, Vaihingen/Enz Ensingen (DE); Ulrich Eisele, Stuttgart (DE); Andre Moc, Grossschoenau (DE)

(73) Assignee: Robert Bosch GmbH, Stuttgart, DE (DE)

(21) Appl. No.: 14/394,417

(22) PCT Filed: Mar. 5, 2013
(86) PCT No.: PCT/EP2013/054415

§ 371 Date: Oct. 14, 2014

(30) Foreign Application Priority Data
Apr. 12, 2012 (DE) 10 2012 205 934.2

(51) Int. Cl. H01M 4/36; H01M 4/485; H01M 4/131; H01M 4/136; H01M 4/58

(52) U.S. Cl. CPC H01M 4/364; H01M 4/136; H01M 4/581; H01M 4/131; H01M 4/485; H01M 2004/028
USPC 429/220; 429/231.95; 429/231.5; 429/231.1; 429/221; 427/126.2

(57) ABSTRACT

A method is described for manufacturing a lithium-sulfur cell or lithium-sulfur battery, in particular a solid-state lithium-sulfur cell or lithium-sulfur battery. A nanowire network is provided in a method step a) composed of an electron- and lithium ion-conducting ceramic mixed conductor or a mixed conductor precursor for forming an electron- and lithium ion-conducting ceramic mixed conductor. The nanowire network is coated with a lithium ion-conducting solid-state electrolyte layer in a method step b). The nanowire network is optionally infiltrated with sulfur in a method step c). A cathode current arrester is applied to the uncoated side of the nanowire network in a method step d). Moreover, a lithium-sulfur cell, a lithium-sulfur battery, and a mobile or stationary system are described as well.

### FIELD OF THE INVENTION

The present invention relates to a method for manufacturing a lithium-sulfur cell or lithium-sulfur battery, a cell and battery of this type, and a mobile or stationary system which is equipped with same.

### BACKGROUND INFORMATION

Lithium-ion batteries are presently of particular interest for mobile communication as well as for entertainment media, and have high energy storage capacities of approximately 100 Wh/kg.

However, this is not the case for electric vehicles. For example, covering a distance of 400 km at a consumption rate of 15 kWh/100 km would require a battery weighing 600 kg.

Lithium-sulfur batteries have the potential for achieving an energy density of approximately 600 Wh/kg or greater. The overall reaction in a lithium-sulfur cell may be expressed as follows: 2 Li+S=Li₂S, and delivers a voltage of 2.3 V.

However, at the present time most lithium-sulfur batteries have a limited cycle rate.

When carbon-sulfur composites, for example, are used, a low cycle rate and capacity may be due to a structural change in the composite caused, for example, by a phase change of the sulfur, in which three-phase boundary areas between sulfur, carbon and electrolyte gradually become smaller.

Another possible reason for a low cycle rate may be corrosion of a metallic lithium anode by the electrolyte, the electrolyte solvent, and/or polysulfides.

German Published Patent Application No. 10 2010 001 632 describes a lithium cell and a method for manufacturing same.

### SUMMARY

An object of the present invention is a method for manufacturing a lithium-sulfur cell or lithium-sulfur battery.

The method according to the present invention advantageously allows the manufacture of a lithium-sulfur cell or lithium-sulfur battery in a particularly simple and economical manner. The method is suited in particular for manufacturing a lithium-sulfur battery which includes two or more lithium-sulfur cells connected in series, in particular stacked on top of or against one another.

The method according to the present invention has little or no need for high-temperature steps, as the result of which the manufacturing costs may advantageously be reduced.

Due to the solid-state electrolyte layer and the cathode current arrester, the lithium metal anode is advantageously protected against corrosion by the sulfur in the cathode. As will be explained below, the solid-state electrolyte layer and the cathode current arrester may form a self-supporting structure, which in particular greatly simplifies the manufacture. In addition, coating of the lithium metal anode may advantageously be dispensed with.

The nanowire network advantageously allows transport of lithium ions and electrons through the cathode material, and provides the sulfur with a large reaction surface, in particular for the deposition of Li₂S.

The method according to the present invention is suited in particular for manufacturing a solid-state lithium-sulfur cell, in particular a solid-state lithium-sulfur battery. Addition of fluid, for example electrolyte fluid, and/or other flammable components may therefore advantageously be dispensed with in the cells and batteries according to the present invention. The cells and batteries according to the present invention may therefore meet stringent safety standards. In addition, the solid-state lithium-sulfur cells according to the present invention may advantageously be connected in series without the possibility of electrolyte fluid escaping and corroding cell components such as the anode.

Due to a series connection of multiple cells according to the present invention, current arresters which arrest the electron flow from/to a cell may advantageously be dispensed with, since the electrons are able to flow directly, in particular perpendicularly, to the boundary surface, in particular from one cell into the next cell. Therefore, one cathodic current accumulator and one anodic current accumulator per cell stack are sufficient. This has the advantage that a limitation of the (dis)charge rate due to a limited cross section of the current accumulators may thus be largely eliminated.

Computations show that the cells according to the present invention may have an energy density of up to 600 Wh/kg, based on the cell.

Overall, the method according to the present invention allows the manufacture of lithium-sulfur cells and lithium-sulfur batteries which deliver essentially constant power and have a high cycle rate and capacity over a large number of discharge/charge cycles.

The method includes method step a), in which a nanowire network is provided, composed of an electron- and lithium ion-conducting ceramic mixed conductor or a mixed conductor precursor for forming an electron- and lithium ion-conducting ceramic mixed conductor. Due to the nanowire network, in particular the mixed conductor of the nanowire network, lithium ions and electrons may advantageously be transported through the electrochemically active cathode material.

In addition, the method includes method step b), in which the nanowire network is coated with a solid-state electrolyte layer which is conductive for lithium ions and nonconductive in particular for electrons, and which in particular is ceramic. A self-supporting structure may advantageously be provided by coating the nanowire network with the solid-state electrolyte layer.

In one specific embodiment, the nanowire network is coated with the solid-state electrolyte layer in method step b) in such a way that the solid-state electrolyte layer covers a main surface, for example the top surface or the bottom surface, in particular the top surface, of the nanowire network as well as at least one lateral surface of the nanowire network which adjoins the main surface. A main surface may be understood in particular to mean a surface which delimits the nanowire network on one side and which in particular has a large, for example, the largest, surface area of the surfaces delimiting the nanowire network. For example, the nanowire network may include two oppositely situated main surfaces of essentially the same size, whereby the upper surface may be referred to as the top surface, and the lower surface may be referred to as the bottom surface. In the case of an essentially cylindrical shape of the nanowire network, for example, one lateral surface, or, in the case of an essentially cuboidal shape of the nanowire network, for example, multiple lateral surfaces, for example four lateral surfaces, may extend between the two main surfaces and adjoin the two main surfaces. For example, the solid-state electrolyte layer may be applied to the nanowire network in method step b) in such a way that the solid-state electrolyte layer covers the top surface as well as the lateral surfaces of the nanowire network. If the solid-state electrolyte layer is applied to the top surface in method step b), and in particular if, after method step b), an infiltration method step, for example method step c) and/or b1) explained below, is to take place, the arrangement is rotated after application of the solid-state electrolyte layer in method step c), so that the side of the nanowire network which is not coated, in particular not coated with the solid-state electrolyte layer, is on top, and in particular the section of the solid-state electrolyte layer which is formed by coating the top layer of the nanowire network is on the bottom.

For example, the nanowire network may be coated with the solid-state electrolyte layer in method step b) in such a way that the solid-state electrolyte layer has an essentially dish-shaped, in particular dish-shaped, design. The nanowire network may in particular be surrounded by the essentially dish-shaped solid-state electrolyte layer.

As a result of the lateral surfaces of the nanowire network also being coated with the solid-state electrolyte layer, a self-supporting structure may advantageously be provided which partially surrounds the nanowire network and, for example, partially encases it.

In one specific embodiment, method step b) is carried out with the aid of an aerosol coating.

Although it is possible in principle to provide a nanowire network which is already infiltrated with sulfur in method step a), in particular if the solid-state electrolyte layer laterally surrounds the nanowire network and has a dish-shaped design, for example, it is recommended that the infiltration of the nanowire network with sulfur be carried out after the solid-state electrolyte layer is formed in method step b). The sulfur may thus advantageously fill the entire interior space which is formed by the solid-state electrolyte layer and which surrounds the nanowire network.

In another specific embodiment, the method therefore includes method step c) of infiltrating the nanowire network with sulfur, in particular after method step b) and before method steps d) and e), explained below. Molten sulfur, a sulfur solution, and/or gaseous sulfur, for example, may be used in method step c).

In addition, the method includes in particular method step d): applying a cathode current arrester to a side of the nanowire network which is not coated, in particular not coated with the solid-state electrolyte layer. A self-supporting, in particular closed, structure may thus advantageously be provided.

In another specific embodiment, the cathode current arrester is applied in method step d) in such a way that the nanowire network is enclosed between, and in particular by, the cathode current arrester and the solid-state electrolyte layer. A self-supporting closed structure may thus advantageously be provided which in particular is also used as a type of housing for the sulfur-infiltrated nanowire network, and which may be further processed particularly well. A metal foil in particular may be used as the cathode current arrester. The metal foil is preferably made of a metal or a metal alloy which is nonreactive to sulfur. For example, the metal foil may be made of aluminum and/or gold and/or an alloy thereof.

In one specific embodiment, the cathode current arrester, in particular the metal foil of the cathode current arrester, includes an electrically conductive, in particular thin, protective layer on the side which (subsequently) faces the anode layer. A chemical reaction of the cathode current arrester with the anode may thus advantageously be avoided. The protective layer may be made of titanium nitride and/or tantalum nitride, for example.

In another specific embodiment, the method includes method step e): applying an anode layer made of metallic lithium or a lithium alloy to the solid-state electrolyte layer, in particular to a side of the solid-state electrolyte layer opposite from the cathode current arrester, and/or to the cathode current arrester. The anode layer may be a foil made of metallic lithium or a lithium alloy, for example.

As the result of applying an anode layer to the solid-state electrolyte layer, a lithium-sulfur cell may be formed with one cathode which is formed by the sulfur-infiltrated nanowire network formed in the preceding method steps.

An anode layer which is applied to the cathode current arrester may be used as the anode for a further lithium-sulfur cell, which in particular is manufactured or designed in the same way, and which in particular may be stacked on or against the anode layer in such a way that the solid-state electrolyte layer of the further lithium-sulfur cell contacts the anode layer, in particular on a side opposite from the cathode current arrester of the further lithium-sulfur cell.

In another specific embodiment, the nanowire network includes at least one lithium titanate, in particular as a mixed conductor or mixed conductor precursor. In particular, the nanowire network may be composed of at least one lithium titanate.

Lithium titanates, which may also be referred to as lithium titanium oxides, advantageously undergo only a small change in volume between the charging operation and the discharging operation, which in turn has an advantageous effect on the contact between the nanowire network and the solid-state electrolyte layer, which is conductive for lithium ions. As a result, contact losses and accompanying capacity losses may in turn be avoided during repeated charging and discharging operations, thus improving the cycling stability of the cell.

The at least one lithium titanate may be based on the general chemical formula Li₄Ti₅O₁₂, for example.

In particular, the at least one lithium titanate may be a lithium titanate into which lithium is inserted, and/or which is calcined under a reducing atmosphere, and/or which is iron-doped and/or copper-doped.

An insertion (intercalation) of additional lithium into a lithium titanate may be described in particular by the formula Li₄₊ₓTi₅O₁₂. For example, the relation 0<x≦3 may apply. The lithium ion conductivity may advantageously be increased by inserting additional lithium into a lithium titanate. In addition, the electrical conductivity may also be greatly increased by a lithium insertion. An insertion of additional lithium into a lithium titanate may take place by chemical and/or electrochemical means, for example.

Although it is possible in principle for a nanowire network composed of a lithium-inserted mixed conductor to already be provided in method step a), in particular if the solid-state electrolyte layer laterally surrounds the nanowire network and has a dish-shaped design, for example, it is recommended that the insertion of lithium into the mixed conductor or the mixed conductor precursor be carried out after the solid-state electrolyte layer is formed in method step b).

In another specific embodiment, however, the method includes method step b1): inserting lithium into the mixed conductor or the mixed conductor precursor of the nanowire network. The mixed conductor or the mixed conductor precursor may in particular be a lithium titanate or a mixture of lithium titanates. For example, lithium vapor, molten lithium, lithium particles, in particular fine lithium particles, or an organic lithium compound, for example butyllithium, may be used for inserting lithium into the mixed conductor or the mixed conductor precursor. As the result of inserting lithium, it is advantageously possible to increase the lithium ion conductivity and electron conductivity in particular of lithium titanates. In this way, for example, a nanowire network composed of a mixed conductor precursor which has little or no lithium ion conductivity or electron conductivity may be provided with lithium ion- and electron-conductive properties. Method step b1) may in particular take place after method step b) and before method step c).

A high electrical conductivity may advantageously be achieved by calcination of a lithium titanate under a reducing atmosphere. The reducing atmosphere may in particular include hydrogen, and may be, for example, a noble gas-hydrogen atmosphere, in particular an argon-hydrogen atmosphere. The hydrogen component may be greater than or equal to 5% by volume to less than or equal to 20% by volume, based on the total volume of the gases in the reducing atmosphere.

Copper- and/or iron-doped lithium titanates have proven to be particularly advantageous, since they may have good electrical conductivity.

Alternatively or additionally, the at least one lithium titanate may be doped with niobium and/or tantalum.

In particular, the at least one lithium titanate may be based on the following general chemical formula: Li_{4+x-y-z}Fe_{3y}Cu_{z}Ti_{5-2y-m}(Nb,Ta)ₘO₁₂ or may correspond to same, where 0≦x≦3, 0≦y≦1, in particular 0.2≦y≦1, for example 0.2 or 0.25 or 0.345≦y≦0.75 or 1, for example 0.345≦y≦0.75, z≧0, in particular 0≦z≦0.2, and 0≦m≦0.1. Lithium titanates of this type have proven to be particularly advantageous, since they may have a high lithium ion conductivity and electron conductivity.

The term “based on” may be understood to mean that the at least one lithium titanate may include additional elements, in particular as doping, in addition to the elements stated in the formula.

The term “corresponds to” may be understood in particular to mean that the at least one lithium titanate includes no additional elements apart from the elements stated in the formula.

Based on the advantages described above, it is preferred that z>0 and/or y>0 and/or x>0, and/or that the at least one lithium titanate is calcined under a reducing atmosphere.

The nanowire network, in particular a nanowire network composed of at least one lithium titanate, may be produced in particular by hydrothermal synthesis. In particular, the nanowire network may be subjected to an ion exchange and/or a thermal treatment after the hydrothermal synthesis. For example, it is possible to initially form a nanowire network from a lithium-free titanate by hydrothermal synthesis, and to subsequently subject the nanowire network to an ion exchange in which ions of the titanate, for example protons, are replaced by lithium ions. A thermal treatment may be used to convert the titanate into a thermodynamic form, in particular a crystal structure, while preserving the nanowire network. This type of synthesis route is described in greater detail in conjunction with FIG. 2, based on Li₄Ti₅O₁₂.

In another specific embodiment, the solid-state electrolyte layer includes at least one lithium-containing material having a garnet-like crystal structure and/or at least one lithium lanthanum zirconium oxide, in particular having a garnet-like crystal structure. In particular, the solid-state electrolyte layer may be formed from at least one material having a garnet-like crystal structure and/or at least one lithium lanthanum zirconium oxide, in particular having a garnet-like crystal structure. For example, the solid-state electrolyte layer may include or be formed from at least one lithium lanthanum zirconium oxide, in particular having a garnet-like crystal structure, which is based on the general chemical formula Li₇La₃Zr₂O₁₂, and in particular which may also contain tantalum and/or niobium and/or aluminum and/or silicon and/or gallium and/or germanium, in particular tantalum and/or aluminum. Lithium lanthanum zirconium oxides of this type may advantageously have a particularly high lithium ion conductivity.

Method steps a), b), optionally c) and/or b1), and d), or method steps a), b), optionally c) and/or b1), d), and e) may be repeated once or multiple times, in particular in this sequence.

Two or more cell arrangements resulting from a repetition of method steps a), b), optionally c) and/or b1), and d), or method steps a), b), optionally c) and/or b1), d), and e) may be stacked on or against one another in a method step f) in such a way that the cell arrangements are connected, in particular directly, in series without additional anode current arresters, for example, connected in between.

One of the two outermost cell arrangements may be provided in method step d), in particular on the side of its solid-state electrolyte layer opposite from its cathode current arrester, with an anode layer, the other of the two outermost cell arrangements not being provided with an anode layer in method step d), so that here a cathode current arrester represents the outermost layer of the cell arrangement.

An anode current arrester may be applied to the anode layer of the outermost cell arrangements provided with the anode layer, in particular on the side of the anode layer facing the solid-state electrolyte layer, in particular in a method step g).

External current arresters may then be applied to the outermost cathode current arrester and the (one, outermost) anode current arrester, in particular in a method step h).

The arrangement, in particular the cell stack, may subsequently be packaged, encased, and/or encapsulated in particular in a method step g). A polymer, for example, may be used for this purpose. For example, the cell stack may be encapsulated with a polymer. A polymer which in particular is impermeable to oxygen, water, and carbon dioxide may be used as the polymer.

With regard to further technical features and advantages of the method according to the present invention, explicit reference is hereby made to the discussions concerning the lithium-sulfur cell according to the present invention, the lithium-sulfur battery according to the present invention, the mobile or stationary system according to the present invention, and to the figures.

A further subject matter of the present invention relates to a lithium-sulfur cell, in particular a solid-state lithium-sulfur cell, which includes a cathode, an anode, and a solid-state electrolyte layer which in particular is ceramic and which is conductive for lithium ions. The anode is made of metallic lithium or a lithium alloy. The solid-state electrolyte layer may be composed, for example, of a ceramic material which is conductive for lithium ions, or a ceramic ion conductor, for example a ceramic lithium ion conductor, which is conductive for lithium ions. The cathode includes a sulfur-infiltrated nanowire network composed of an electron- and lithium ion-conducting ceramic mixed conductor.

The solid-state electrolyte layer includes in particular a section which separates the cathode from the anode. In addition, the solid-state electrolyte layer includes in particular at least one further section which at least partially laterally surrounds the cathode. For example, the solid-state electrolyte layer may include at least one further section which laterally surrounds, encloses, or delimits the cathode, in particular completely.

The lithium-sulfur cell may be manufactured in particular by a method according to the present invention.

In one specific embodiment, the solid-state electrolyte layer has an essentially dish-shaped, in particular dish-shaped, design. The cathode is situated within the essentially dish-shaped solid-state electrolyte layer or accommodated therein.

In another specific embodiment, the lithium-sulfur cell includes a cathode current arrester. In particular, the cathode may be enclosed between, and in particular by, the cathode current arrester and the solid-state electrolyte layer, in particular the essentially dish-shaped solid-state electrolyte layer. The cathode current arrester may in particular close or cover the opening in the essentially dish-shaped solid-state electrolyte layer.

In another specific embodiment, the cathode current arrester includes an electrically conductive protective layer on the side facing away from the cathode. For example, the protective layer may be made of titanium nitride and/or tantalum nitride. The cathode current arrester may in particular be made of aluminum and/or gold and/or an alloy thereof.

In another specific embodiment, the nanowire network, in particular as a mixed conductor or mixed conductor precursor, includes at least one lithium titanate. In particular, the nanowire network may be formed from at least one lithium titanate. The at least one lithium titanate may be based on the general chemical formula Li₄Ti₅O₁₂, for example. In particular, the at least one lithium titanate may be a lithium titanate into which lithium is inserted, and/or which is calcined under a reducing atmosphere, and/or which is iron-doped and/or copper-doped.

In particular, the at least one lithium titanate may be based on the following general chemical formula: Li_{4+x-y-z}Fe_{3y}Cu_{z}Ti_{5-2y-m}(Nb,Ta)ₘO₁₂ or may correspond to same, where 0≦x≦3, 0≦y≦1, in particular 0.2≦y≦1, for example 0.2 or 0.25 or 0.345≦y≦0.75 or 1, for example 0.345≦y≦0.75, z≧0, in particular 0≦z≦0.2, and 0≦m≦0.1. Lithium titanates of this type have proven to be particularly advantageous, since they may have a high lithium ion conductivity and electron conductivity. Based on the advantages described above, it is preferred that z>0 and/or y>0 and/or x>0, and/or that the at least one lithium titanate is calcined under a reducing atmosphere.

The nanowire network, in particular a nanowire network composed of at least one lithium titanate, may be produced in particular by hydrothermal synthesis. In particular, the nanowire network may be subjected to an ion exchange and/or a thermal treatment after the hydrothermal synthesis.

In another specific embodiment, the solid-state electrolyte layer includes at least one lithium-containing material having a garnet-like crystal structure and/or at least one lithium lanthanum zirconium oxide, in particular having a garnet-like crystal structure. In particular, the solid-state electrolyte layer may be formed from at least one material having a garnet-like crystal structure and/or at least one lithium lanthanum zirconium oxide, in particular having a garnet-like crystal structure. For example, the solid-state electrolyte layer may include or be formed from at least one lithium lanthanum zirconium oxide, in particular having a garnet-like crystal structure, which is based on the general chemical formula Li₇La₃Zr₂O₁₂, and in particular which may also contain tantalum and/or niobium and/or aluminum and/or silicon and/or gallium and/or germanium, in particular tantalum and/or aluminum. Lithium lanthanum zirconium oxides of this type may advantageously have a particularly high lithium ion conductivity.

With regard to further technical features and advantages of the lithium-sulfur cell according to the present invention, explicit reference is hereby made to the discussions concerning the method according to the present invention, the lithium-sulfur battery according to the present invention, the mobile or stationary system according to the present invention, and to the figures.

A further subject matter of the present invention relates to a lithium-sulfur battery, in particular a solid-state lithium-sulfur battery, which includes two or more lithium-sulfur cells according to the present inventions and/or which is manufactured by a method according to the present invention. The lithium-sulfur cells may be connected in series in the battery. In particular, the lithium-sulfur cells may be stacked on or against one another for connecting the lithium-sulfur cells in series. In particular, only one current arrester, in particular one cathode current arrester, may be situated between the lithium-sulfur cells.

The lithium-sulfur battery may in particular be manufactured by a method according to the present invention.

With regard to further technical features and advantages of the battery according to the present invention, explicit reference is hereby made to the discussions concerning the method according to the present invention, the lithium-sulfur cell according to the present invention, the mobile or stationary system according to the present invention, and to the figures.

A further subject matter of the present invention relates to a mobile or stationary system which includes a lithium-sulfur cell according to the present invention and/or a lithium-sulfur battery according to the present invention. In particular, the mobile or stationary system may be a vehicle, for example a hybrid vehicle, a plug-in hybrid vehicle, or an electric vehicle, an energy storage system, for example for stationary energy storage, for example in a residence or a technical facility, an electric tool, an electric gardening tool, or an electronic device, for example a sensor, a smart card, a notebook, a PDA, or a mobile telephone.

With regard to further technical features and advantages of the mobile or stationary system according to the present invention, explicit reference is hereby made to the discussions concerning the method according to the present invention, the lithium-sulfur cell according to the present invention, the lithium-sulfur battery according to the present invention, and to the figures.

### BRIEF DESCRIPTION OF THE DRAWINGS

FIGS. 1a through 1h show schematic cross sections for explaining one specific embodiment of the method according to the present invention for manufacturing a lithium-sulfur cell or lithium-sulfur battery.

FIG. 2 shows a flow chart for explaining the manufacture of a nanowire network with the aid of hydrothermal synthesis.

### DETAILED DESCRIPTION

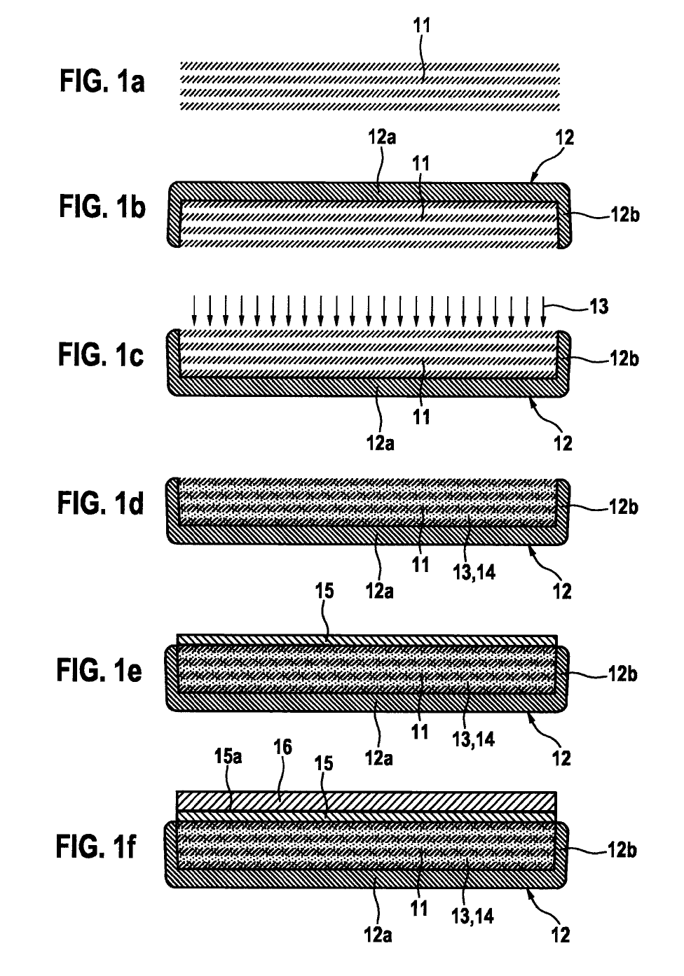

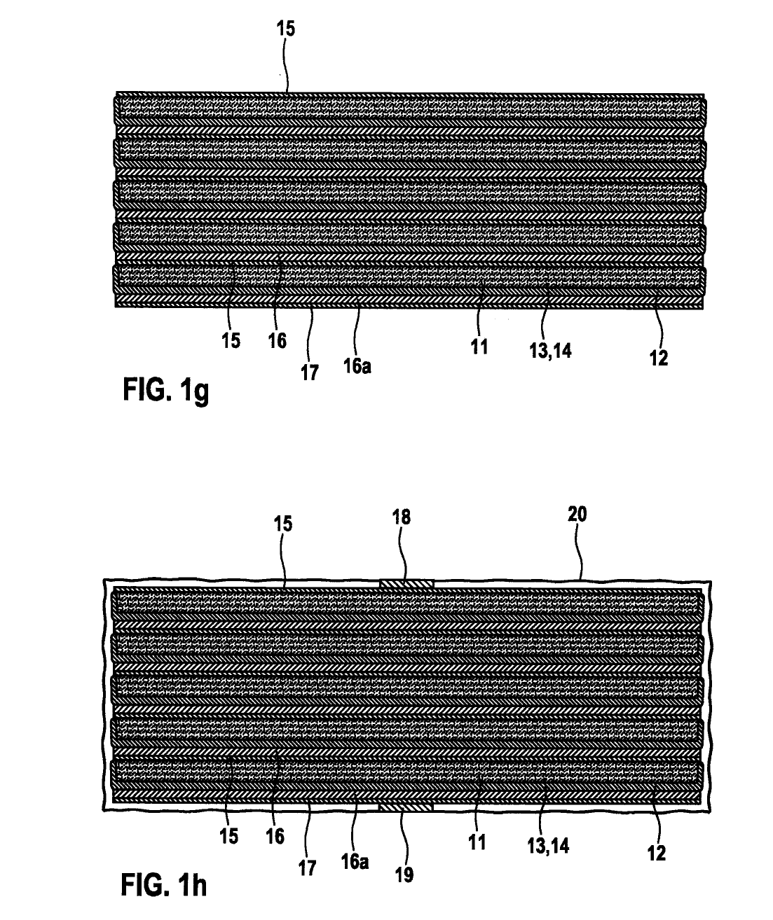

FIG. 1a shows that a nanowire network 11, composed of an electron- and lithium ion-conducting ceramic mixed conductor or a mixed conductor precursor for forming an electron- and lithium ion-conducting ceramic mixed conductor, is initially provided in a method step a).

FIG. 1b shows that nanowire network 11 is coated with a lithium ion-conducting solid-state electrolyte layer 12, 12a, 12b in a method step b). Nanowire network 11 is coated with solid-state electrolyte layer 12, 12a, 12b in such a way that the top surface of nanowire network 11 is coated with a section 12a of solid-state electrolyte layer 12, 12a, 12b, the lateral surfaces of nanowire network 11 which adjoin the top surface being covered by sections 12b of solid-state electrolyte layer 12, 12a, 12b. FIG. 1b shows that solid-state electrolyte layer 12, 12a, 12b assumes an essentially dish-shaped form.

FIG. 1c shows that the arrangement according to method step b) has been rotated by 180°, so that section 12b of solid-state electrolyte layer 12, 12a, 12b, which has been formed by coating the top surface of nanowire network 11, is now on the bottom, and the uncoated side of nanowire network 11 is on top. The arrows in FIG. 1c illustrate that lithium 13 is inserted into the mixed conductor or the mixed conductor precursor of nanowire network 11 in a method step b1).

FIG. 1d shows that nanowire network 11 has subsequently been infiltrated with sulfur 14 in a method step c).

FIG. 1e shows that a cathode current arrester 15 has been applied to the uncoated side of nanowire network 11 in a method step d) in such a way that nanowire network 11 together with the lithium inserted therein and the infiltrated sulfur is enclosed between cathode current arrester 15 and solid-state electrolyte layer 12, 12a, 12b.

FIG. 1f shows that an anode layer 16 made of metallic lithium or a lithium alloy has been applied to cathode current arrester 15 in a method step e). This anode layer forms the anode for the next cell arrangement subsequently applied thereto. To avoid a chemical reaction between anode layer 16 and cathode current arrester 15, cathode current arrester 15, which is applied in particular in method step d), includes an electrically conductive protective layer 15a, composed of titanium nitride and/or tantalum nitride, for example, on the side facing anode layer 16.

As illustrated in FIGS. 1g and 1h, method steps a) through e) may be repeated multiple times, and the resulting cell arrangements may be stacked on top of one another in a method step f) in such a way that the cell arrangements are directly connected in series via cathode current arresters 15, i.e., without additional anode current arresters connected in between, and form a cell stack.

FIG. 1g shows that multiple cell arrangements have been assembled flatly on top of one another to form a cell stack in method step f). FIG. 1g shows that for completion of the first, i.e., lowermost, cell arrangement, a further anode layer 16a has been applied on the side of solid-state electrolyte layer 12, 12a, 12b of the first, i.e., lowermost, cell arrangement opposite from cathode current arrester 15 in a method step a). In addition, an anode current arrester 17 has been applied to further anode layer 16a on the side of anode layer 16a facing away from solid-state electrolyte layer 12, 12a, 12b in a method step g).

FIG. 1g illustrates that the last, i.e., topmost, cell arrangement has not been provided with an anode layer 16 in method step d), so that in this case, cathode current arrester 16 of this cell arrangement represents the outermost layer of the cell stack.

FIG. 1h shows that external current arresters 18, 19 have been applied to anode current arrester 17 (bottom) and outermost cathode current arrester 15 (top), respectively, in a method step h), and the cell stack has been encapsulated in a polymer 20 in a method step g).

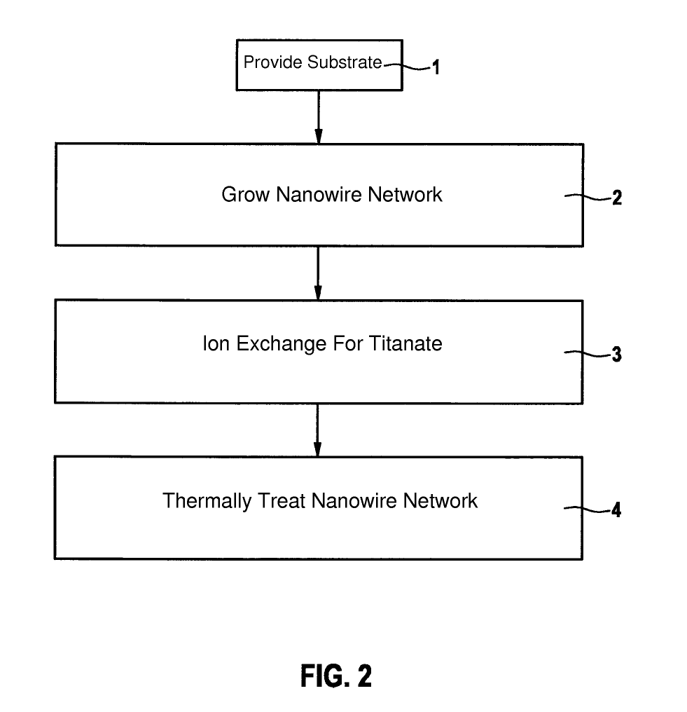

FIG. 2 is a flow chart for explaining the manufacture of a nanowire network composed of lithium titanate (Li₄Ti₅O₁₂) with the aid of hydrothermal synthesis.

FIG. 2 shows that a substrate is provided in a first method step 1.

A nanowire network is grown on the substrate from hydrogen-containing titanates with the aid of hydrothermal synthesis in a second method step 2. This may take place in particular under strongly basic conditions, for example in a 10 M sodium hydroxide (NaOH) solution, at a temperature of greater than or equal to 125° C., for example approximately 170° C., for a reaction period of greater than or equal to 10 hours, for example 12 to 72 hours. The morphology of the nanowire network may be formed in this way.

The chemical composition of the nanowire network is influenced in a third method step 3, in that the hydrogen-containing titanate is subjected to an ion exchange in which the protons of the titanate are replaced by lithium ions. For example, an ion exchange of protons with lithium ions may likewise be carried out under hydrothermal conditions. For example, a 0.2 M lithium hydroxide (LiOH) solution may be used for this purpose. The temperature may be greater than or equal to 125° C., for example approximately 150° C. The reaction period may be greater than or equal to 10 hours, for example approximately 24 hours. A particularly suitable Li:Ti ratio of 4:5 may thus be achieved with titanates having a spinel structure.

The crystal structure of the nanowire network is influenced in a fourth method step 4. For this purpose, the nanowire network is thermally treated and heated, for example, to a temperature greater than or equal to 500° C., for example to a temperature in a range of greater than or equal to 500° C. to less than or equal to 700° C. In this way, anisotropic lithium titanate may be converted into a thermodynamically stable form without changing the morphology of the nanowire network.

To further increase the lithium ion conductivity and electron conductivity of the lithium titanate (Li₄Ti₅O₁₂) of the nanowire network, the lithium titanate of the nanowire network may subsequently also have lithium inserted or intercalated, resulting in a lithium-inserted lithium titanate of the general chemical formula Li₄₊ₓTi₅O₁₂.

1-15. (canceled)

16. A method for manufacturing one of a lithium-sulfur cell and a lithium-sulfur battery, comprising:
providing a nanowire network composed of one of an electron- and lithium ion-conducting ceramic mixed conductor and a mixed conductor precursor for forming an electron- and lithium ion-conducting ceramic mixed conductor;
coating the nanowire network with a lithium ion-conducting solid-state electrolyte layer;
optionally infiltrating the nanowire network with sulfur; and
applying a cathode current arrester to an uncoated side of the nanowire network.

17. The method as recited in claim 16, wherein the coating includes coating the nanowire network with the solid-state electrolyte layer in such a way that the solid-state electrolyte layer covers a main surface of the nanowire network as well as at least one lateral surface of the nanowire network which adjoins the main surface.

18. The method as recited in claim 17, wherein the main surface includes a top surface.

19. The method as recited in claim 16, wherein the cathode current arrester is applied in such a way that the nanowire network is enclosed between the cathode current arrester and the solid-state electrolyte layer.

20. The method as recited in claim 16, further comprising:
applying an anode layer made of one of metallic lithium and a lithium alloy to the solid-state electrolyte.

21. The method as recited in claim 20, wherein the anode layer is applied one of to a side of the solid-state electrolyte layer opposite from the cathode current arrester and to the cathode current arrester.

22. The method as recited in claim 16, wherein the nanowire network includes at least one lithium titanate.

23. The method as recited in claim 22, wherein the at least one lithium titanate includes at least one of:
a lithium titanate into which lithium is inserted,
a lithium titanate which is calcined under a reducing atmosphere, and
a lithium titanate which is at least one of iron-doped and copper-doped.

24. The method as recited in claim 16, further comprising:
inserting lithium into the one of the mixed conductor and the mixed conductor precursor of the nanowire network.

25. The method as recited in claim 16, wherein the solid-state electrolyte layer includes at least one lithium lanthanum zirconium oxide having a garnet-like crystal structure.

26. The method as recited in claim 25, wherein the at least one lithium lanthanum zirconium oxide is based on the general chemical formula Li7La3Zr2O12, and contains at least one of tantalum and aluminum.

27. The method as recited in claim 20, wherein the cathode current arrester includes an electrically conductive protective layer on a side facing the anode layer.

28. The method as recited in claim 27, wherein the electrically conductive protective layer is made of at least one of titanium nitride and tantalum nitride.

29. A lithium-sulfur cell, comprising:
a cathode;
an anode made of one of metallic lithium and a lithium alloy; and
a lithium ion-conducting solid-state electrolyte layer, wherein the cathode includes a nanowire network infiltrated with sulfur and composed of an electron- and lithium ion-conducting ceramic mixed conductor, wherein the solid-state electrolyte layer includes a section that separates the cathode from the anode, and wherein the solid-state electrolyte layer includes at least one further section which at least partially laterally surrounds the cathode.

30. The lithium-sulfur cell as recited in claim 29, wherein the solid-state electrolyte layer has an essentially dish-shaped design.

31. The lithium-sulfur cell as recited in claim 30, wherein the cathode is situated within the essentially dish-shaped solid-state electrolyte layer.

32. The lithium-sulfur cell as recited in claim 29, further comprising a cathode current arrester.

33. The lithium-sulfur cell as recited in claim 32, wherein the cathode is enclosed between the cathode current arrester and the solid-state electrolyte layer.

34. The lithium-sulfur cell as recited in claim 32, wherein the cathode current arrester includes an electrically conductive protective layer.

35. The lithium-sulfur cell as recited in claim 34, wherein the electrically conductive protective layer is made of at least one of titanium nitride and tantalum nitride, on a side facing away from the cathode.

36. The lithium-sulfur cell as recited in claim 29, wherein the nanowire network includes at least one lithium titanate.

37. The lithium-sulfur cell as recited in claim 36, wherein the lithium titanate at least one of:
has lithium inserted therein,
is calcined under a reducing atmosphere, and
is at least one of iron-doped and copper-doped.

38. The lithium-sulfur cell as recited in claim 29, wherein the solid-state electrolyte layer includes at least one lithium lanthanum zirconium oxide having a garnet-like crystal structure.

39. The lithium-sulfur cell as recited in claim 38, wherein the lithium lanthanum zirconium oxide is based on the general chemical formula Li7La3Zr2O12 and contains at least one of tantalum and aluminum.

40. The method as recited in claim 16, wherein the one of the lithium-sulfur cell and the lithium-sulfur battery includes one of a solid-state lithium-sulfur cell and a solid-state lithium-sulfur battery.

41. The lithium-sulfur cell as recited in claim 29, wherein the lithium-sulfur cell includes a solid-state lithium-sulfur cell.

42. The method as recited in claim 16, wherein the coating includes coating the nanowire network with the solid-state electrolyte layer in such a way that the solid-state electrolyte layer covers a main surface of the nanowire network as well as lateral surfaces of the nanowire network which adjoin the main surface.

43. The method as recited in claim 16, wherein the coating is carried out with the aid of an aerosol coating.
